(19) United States
(12) Patent Application Publication
(10) Pub. No.: US 2013/0264746 A1
(43) Pub. Date: Oct. 10, 2013

(54) APPARATUS AND METHOD FOR SELECTIVE MICRO PATTERN REPLICATION USING ULTRASONIC WAVES

(71) Applicants: Keun Park, Seoul (KR); Woosin Jung, Seoul (KR)

(72) Inventors: Keun Park, Seoul (KR); Woosin Jung, Seoul (KR)

(73) Assignee: Seoul National University of Technology Center For Industry Collaboration, Seoul (KR)

(21) Appl. No.: 13/601,313

(22) Filed: Aug. 31, 2012

(30) Foreign Application Priority Data
Apr. 10, 2012 (KR) 10-2012-0037170

(51) Int. Cl. B29C 59/16

(52) U.S. Cl. 264/442; 425/174.2

(57) ABSTRACT

The present invention provides an apparatus for selectively micro pattern replication using ultrasonic waves, the apparatus including: (1) a to-be-processed substrate scheduled to be replicated with a first pattern in a first area which is a part of a predetermined area; (2) a mold provided with a second pattern at least in an area corresponding to the predetermined area, on which the to-be-processed substrate is fixed; (3) a masking layer provided to be contacted with the to-be-processed substrate on a side opposite to a side facing the mold and including a masking area in an area corresponding to the first area; and (4) a tool horn for transferring ultrasonic vibration to the masking layer. If the tool horn transfers the ultrasonic vibration to the masking layer, the to-be-processed substrate is pressed to the mold.

### CROSS REFERENCE TO RELATED APPLICATIONS

This application claims the priority to Korean Patent Application No. 10-2012-0037170 filed on Apr. 10, 2012, the entire content of which is incorporated herein by reference.

### BACKGROUND

1. Technical Field

The present invention relates to an apparatus and method for selective micro pattern replication using ultrasonic waves, and more specifically, to an apparatus and method for selective micro pattern replication using a masking layer.

2. Related Art

As techniques of electronic devices and displays are rapidly advanced and the electronic devices and displays are fine pitched and thin filmed, high integration and improvement in formability are required in the process of a micro pattern replication. The method of a micro pattern replication includes lithography, nano-imprinting, hot embossing, injection molding and the like using a polymer material. However, these methods require additional processes and thus expose various problems from the viewpoints of processing time, production cost and productivity.

Recently, studies on the techniques of improving replicability of micro patterns by applying ultrasonic vibration energy to a hot embossing process are actively progressed as a technique of micro pattern replication using ultrasonic vibration energy. This is a method of locally plasticizing using friction heat generated between plastic base materials by applying ultrasonic excitation to a polymer plastic product.

An example of this technique was disclosed in an academic paper “J. Tsujino, M. Hongoh, R. Onoguchi and T. Ueoka, 2002, Ultrasonic Plastic Welding Using Fundamental and Higher Resonance Frequencies, Ultrason., Vol. 40, No. 1˜8, pp. 375˜378” issued in 2002 and “H. Mekaru, H. Goto, M. Takahashi a, 2007, Development of ultrasonic micro hot embossing technology, Microelectron Engineering., Vol. 84, pp. 1282˜1287” issued in 2007.

A processing method of direct pattern replication by locally plasticizing the surface of a polymer substrate and applying pressure thereon at the same time is proposed in Korean Laid-Open Patent Publication No. 10-2011-0090786 published on Aug. 10,2011. The polymer substrate is plasticized by inducing friction heat between a tool horn and the substrate using vibration energy applied to the ultrasonic tool horn on which the micro pattern is imprinted. At this point, the micro pattern is imprinted in the tool horn or a mold, and it is general to fabricate and use a stamper applying a micro machine or a semiconductor process.

The conventional technique described above is appropriate for micro pattern replication across a predetermined area of a to-be-processed substrate. However, when the micro pattern is desired to be formed in a part of a predetermined area, an additional technique for setting a separate tool path of a micro machine or fabricating a stamper relevant to a corresponding area is required in order to form a shape matching to the micro pattern of the part of the predetermined area. Therefore, it is not easy to micro pattern replication of a complex shape at a low cost through an ultrasonic process.

### SUMMARY

Therefore, the present invention has been made in view of the above problems, and it is an object of the present invention to provide an apparatus and method for selective micro pattern replication in a part of a predetermined area at a low cost.

To accomplish the above object, according to one aspect of the present invention, there is provided an apparatus for selective micro pattern replication using ultrasonic waves, the apparatus including a to-be-processed substrate scheduled to be replicated with a first pattern in a first area which is a part of a predetermined area; a mold provided with a second pattern at least in an area corresponding to the predetermined area, on which the to-be-processed substrate is fixed; a masking layer provided to be contacted with the to-be-processed substrate on a side opposite to a side facing the mold and including a masking area in an area corresponding to the first area; and a tool horn for transferring ultrasonic vibration to the masking layer. If the tool horn transfers the ultrasonic vibration to the masking layer, the to-be-processed substrate is pressed to the mold.

The apparatus according to the second embodiment comprises a to-be-processed substrate scheduled to be replicated with a first pattern in a first area which is a part of a predetermined area; a mold on which the to-be-processed substrate is fixed; a masking layer provided between the to-be-processed substrate and the mold and including a masking area in an area corresponding to the first area; and a tool horn for transferring ultrasonic vibration to the to-be-processed substrate and being provided with a second pattern in an area corresponding to at least the predetermined area. If the tool horn transfers the ultrasonic vibration to the to-be-processed substrate, the to-be-processed substrate is pressed to the masking layer.

In a preferred embodiment of the present invention, the masking layer is made of a thermoplastic resin having a glass transition temperature higher than a glass transition temperature of the to-be-processed substrate.

The method of selective micro pattern replication using ultrasonic waves of the present invention comprises a step of providing a to-be-processed substrate scheduled to be replicated with a first pattern in a first area which is a part of a predetermined area; a step of fixing the to-be-processed substrate to a mold provided with a second pattern at least in an area corresponding to the predetermined area; a step of providing a masking layer including a masking area in an area corresponding to the first area so as to contact with the to-be-processed substrate on a side opposite to a side facing the mold; and a step of transferring ultrasonic vibration to the masking layer and pressing the to-be-processed substrate to the mold.

The method of the second embodiment of the present invention comprises a step of providing a to-be-processed substrate scheduled to be replicated with a first pattern in a first area which is a part of a predetermined area; a step of fixing the to-be-processed substrate to a mold; a step of providing a masking layer including a masking area in an area corresponding to the first area, between the to-be-processed substrate and the mold; and a step of transferring ultrasonic vibration to the to-be-processed substrate through a tool horn provided with the second pattern at least in an area corresponding to the predetermined area and pressing the to-be-processed substrate to the masking layer.

### BRIEF DESCRIPTION OF THE DRAWINGS

FIG. 1 is a view showing the schematic configuration of an ultrasonic imprinting apparatus.

FIGS. 2 and 3 are views showing the process of selective micro pattern replication according to a first embodiment of the invention.

FIGS. 4 and 5 are views showing the process of selective micro pattern replication according to a second embodiment of the invention.

FIG. 6 is a view showing results of selective micro pattern replication according to the invention.

### DETAILED DESCRIPTION

The preferred embodiments of the invention will be hereafter described in detail, with reference to the accompanying drawings.

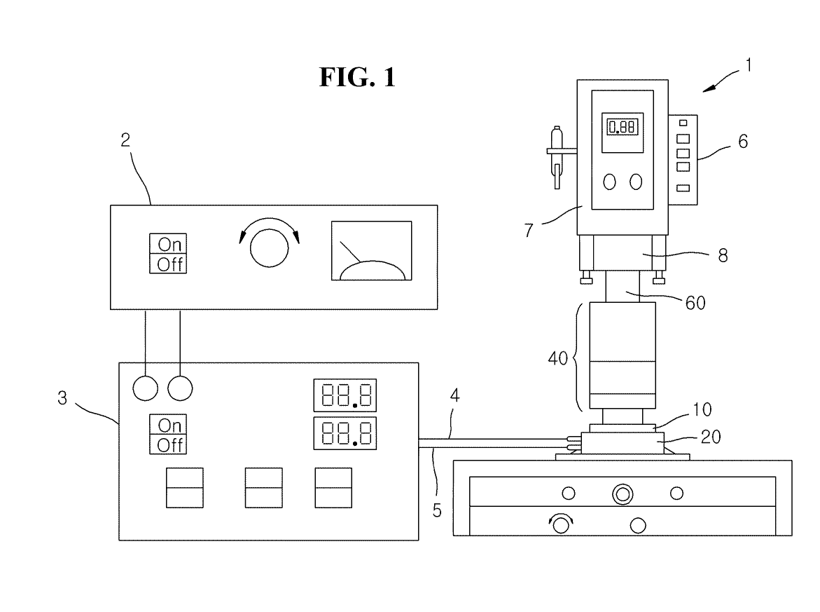

FIG. 1 is a view showing the schematic configuration of an ultrasonic imprinting apparatus. As shown in FIG. 1, the ultrasonic imprinting apparatus 1 includes a control unit 6, a hydraulic press 7, a piezoelectric transducer 8, a tool horn 40 and a booster 60. A forming pattern (not shown in FIG. 1) for micro pattern replication is provided at an end of the tool horn 40, and a to-be-processed substrate 10 on which the micro pattern is replicated and a mold 20 for fixedly resting the to-be-processed substrate are arranged at a position opposite to the forming pattern. Hot water passes through the mold 20 in order to maintain the temperature of the mold 20 to be constant when the micro pattern is replicated. The hot water is supplied by a hot water supply apparatus 3 through a hot water supply pipe 4, and the hot water is collected in the hot water supply apparatus 3 through a hot water collecting pipe 5. The hot water supply apparatus 3 is supplied with power from a power supply 2.

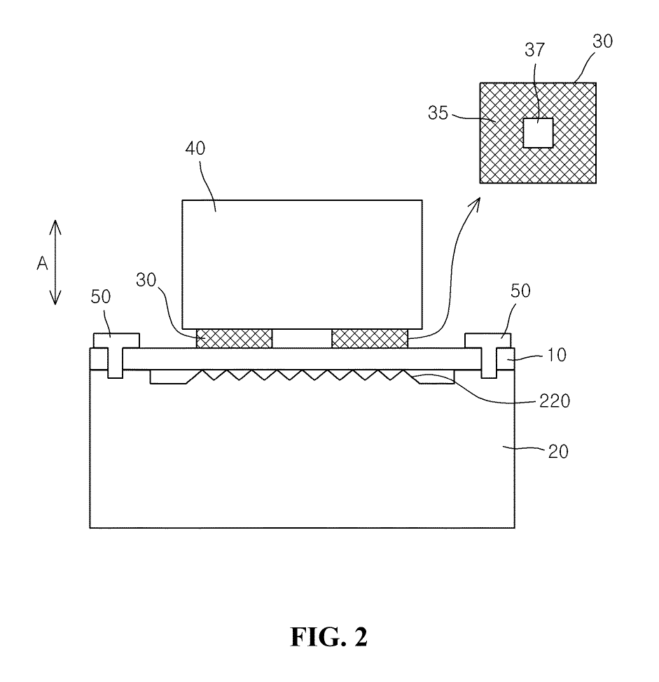

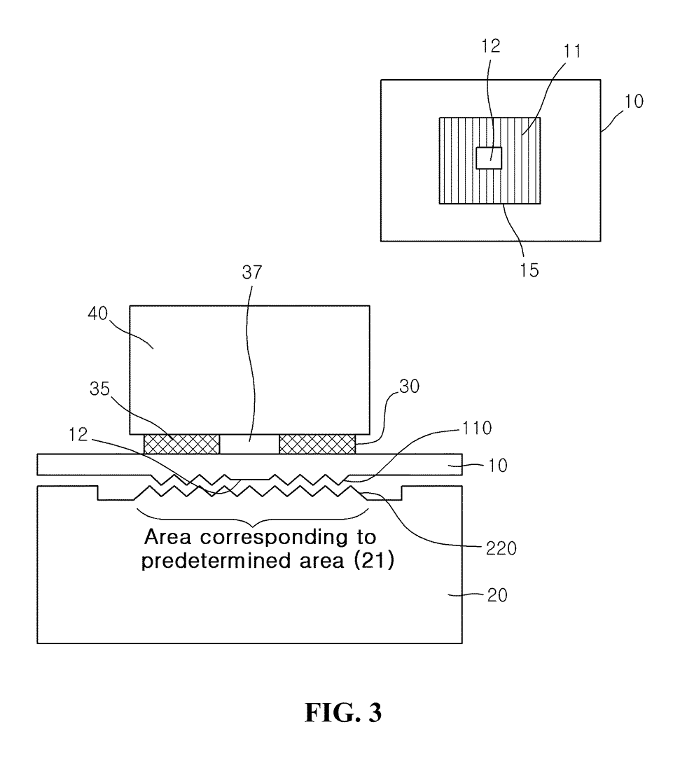

FIG. 2 shows the initial stage of an ultrasonic imprinting process according to a first embodiment of the present invention, and FIG. 3 shows a state of a micro pattern selectively replicated according to the first embodiment. A first area 11 is a part of a predetermined area 15 of the to-be-processed substrate 10 replicated in a rectangular shape as shown in the upper right area of FIG. 3, and although a case of selective micro pattern replication shown in the first area 11 is described in the specification, the shape of the predetermined area 15 is not to be construed as limiting the scope of right of the present invention. When the micro patterns are replicated not in the entire area, but in a part of a specific area, it is understood to those skilled in the art that the present invention can be applied without departing from the technical spirits of the present invention. The predetermined area 15 includes the first area 11 where a first pattern, i.e., a micro pattern, is replicated and a second area 12 where a micro pattern is not replicated. A polymer material can be used for the to-be-processed substrate 10.

A second pattern 220 is replicated in an area 21 (refer to FIG. 3) of the mold 20 corresponding to the predetermined area 15. In this specification, the second pattern 220 is defined as “a complementary pattern where the first pattern replicated on the to-be-processed substrate 10 can be replicated (copied)”, and the second pattern 220 is replicated not only in the area corresponding to the first area 11, but at least in the predetermined area 15. The area 21 corresponding to the predetermined area where the second pattern 220 is replicated only needs to be equal to or wider than the predetermined area 15. The second pattern 220 may be replicated directly on the mold 20 or attached to the mold 20 after being replicated on a separate member.

The to-be-processed substrate 10 is fixed to the mold 20 by a fixing device 50, and a masking layer 30 is provided such that a side opposite to a side facing the mold 20 contacts with the to-be-processed substrate 10. The masking layer 30 is shown at the upper right of FIG. 2 and includes a masking area 35 and a non-masking area 37. The masking area 35 is an area corresponding to the first area 11 where the first pattern is replicated. The diagonal lines drawn in the masking area 35 of FIG. 2 do not mean a pattern, but indicate that it is a masking area. The non-masking area 37 is an area that is removed. The masking layer 30 is preferably configured of a thermoplastic resin having a glass transition temperature Tg higher than that of the to-be-processed substrate 10.

The tool horn 40 vibrates in the A direction by ultrasonic waves and transfers vibration energy to the to-be-processed substrate 10 through the masking layer 30. Although it is described in this embodiment that the tool horn 40 vibrates in the A direction, i.e., in the longitudinal direction, by ultrasonic waves, the tool horn 40 may vibrates in the transversal direction by ultrasonic waves depending on the shape of the pattern. If the ultrasonic vibration energy is transferred as described above, temperature of the to-be-processed substrate 10 rises due to friction heat, and when the temperature of the to-be-processed substrate 10 made of a polymer material arrives at the glass transition temperature Tg, the second pattern 220 replicated on the mold 200 is replicated on the to-be-processed substrate 10 as shown in FIG. 3. At this point, since the masking area 35 of the masking layer 30 exists only in an area corresponding to the first area 11, the effect of the ultrasonic vibration is intensively transferred to a portion contacting with the masking area 35, and thus the friction heat is generated. Therefore, the second pattern 220 is replicated only in the first area 11 where the temperature thereof arrives at the glass transition temperature and plasticity is locally generated, and therefore, the first pattern is replicated. Since the ultrasonic vibration is not transferred directly to the second area 12 corresponding to the non-masking area 37, temperature of the second area 12 does not arrive at the glass transition temperature, and thus the second pattern 220 is not replicated in the second area 12.

As a result, the first pattern is replicated only in the first area 11 of the to-be-processed substrate 10, which is a part of a predetermined area. The present invention provides the effect of forming (copying) a pattern in a part of an area with ease at a low cost by adopting the masking layer 30.

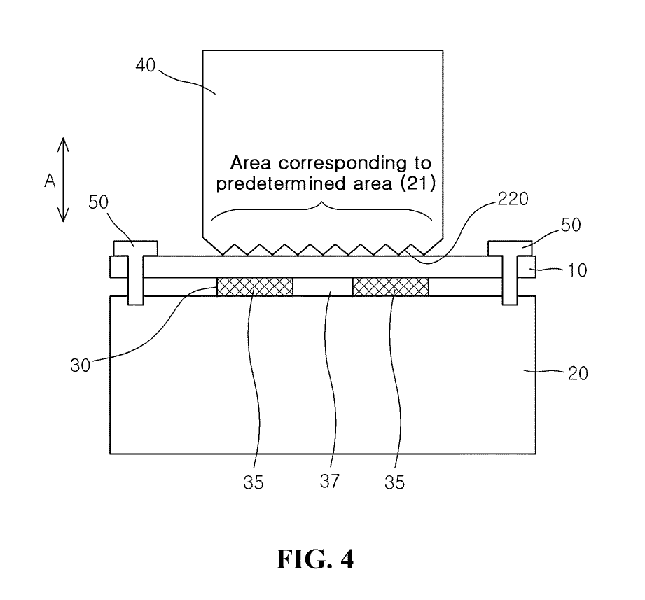

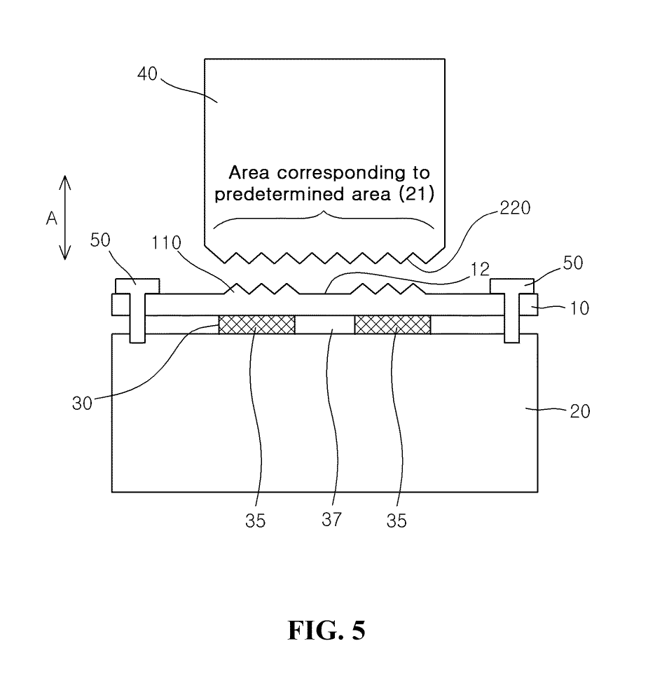

FIG. 4 shows the initial stage of an ultrasonic imprinting process according to a second embodiment of the present invention, and FIG. 5 shows a state of selective micro pattern replication according to the second embodiment.

The second embodiment of the present invention is different from the first embodiment in the positions of the masking layer 30 and the second pattern 220 as shown in FIGS. 4 and 5.

In the second embodiment, the tool horn 40 is provided with the second pattern 220 for replicating the first pattern. The second pattern 220 may be replicated directly on the tool horn 40 or attached to the tool horn 40 after being replicated on a separate member. The second embodiment is assumed to be an embodiment in which a micro pattern (the first pattern) shaped like in the first embodiment is selectively replicated in the first area 11, i.e., a part of the predetermined area 15.

The to-be-processed substrate 10 in which the first pattern will be selectively replicated in the first area 11 is fixed to the mold 20 by the fixing device 50, and the masking layer 30 is interposed between the to-be-processed substrate 10 and the mold 20. The masking layer 30 has a structure described in the first embodiment, but it is arranged at a different position.

In this state, if the tool horn 40 where the second pattern 220 is replicated in the area 21 corresponding to the predetermined area vibrates in the A direction by ultrasonic waves, temperature of the to-be-processed substrate 10 rises due to friction heat, and when the temperature of the to-be-processed substrate 10 arrives at the glass transition temperature, the second pattern 220 provided on the tool horn 40 side is replicated on the to-be-processed substrate 10. At this point, the second pattern 220 is replicated only in the masking area 35 of the masking layer 30, and the second pattern 220 is not replicated on the to-be-processed substrate 10 in the non-masking area 37. As a result, like in the first embodiment, provided is the effect of selectively replicating the first pattern, i.e., a micro pattern, in the first area 11, i.e., a part of the predetermined area 15. Depending on the shape of a pattern, the ultrasonic vibration may be generated in the transversal direction, not in the longitudinal A direction.

Meanwhile, a plurality of masking layers 30 can be used in the first and second embodiments. According to experiments of the inventors, an effect of reducing forming time and increasing formability is observed when a plurality of masking layers 30 is used, and it seems to be since that the temperature of the to-be-processed substrate 10 rises also due to friction heat generated between the masking layers. When thickness of the masking layer 30 is increased instead of using a plurality of stacked masking layers 30, the formability is also improved.

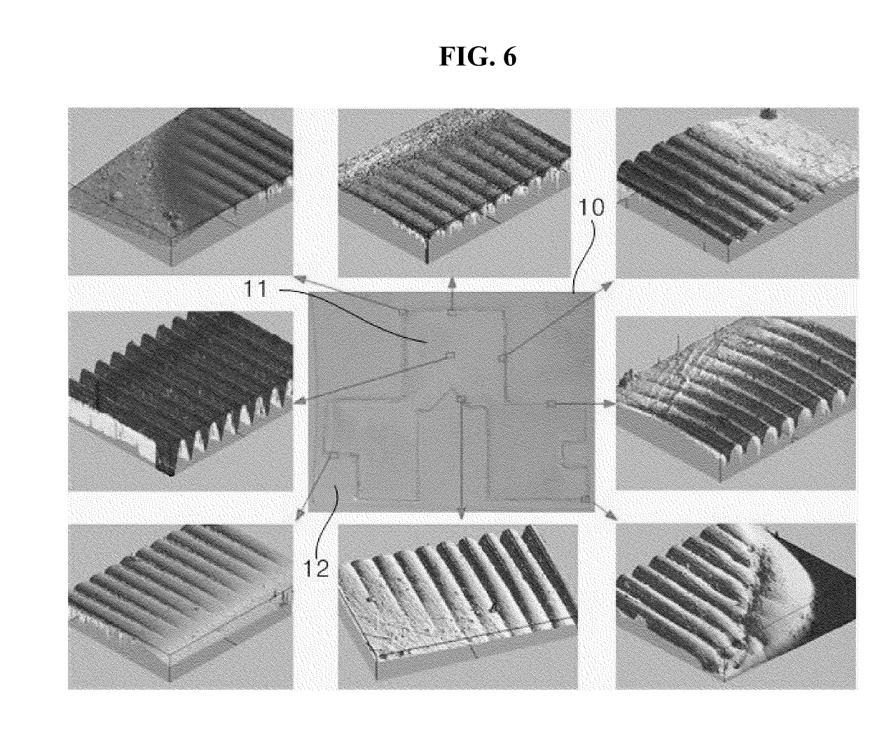

FIG. 6 shows results of actually replicating selective micro patterns and observing the replicated pattern according to the present invention. The to-be-processed substrate 10 has a first area 11 where a micro pattern is selectively replicated and a second area 12 where a micro pattern is not replicated, and difference of micro pattern formability can be observed at the border between the first area 11 and the second area 12. The masking layer 30 is provided in correspondence to the first area 11, and replication of the micro pattern is performed.

According to the present invention, when a micro pattern is desired to be replicated only in a part of a predetermined area, a masking layer is adopted to easily provide a pattern to be replicated to the tool horn or a mold, instead of replicating the micro pattern in a complex, expensive and difficult manner. Therefore, an effect of freely replicating micro patterns in a variety of areas at a low cost is provided. Furthermore, when the same micro pattern is used in different pattern areas, only the masking layer is replaced and used without reprocessing the tool horn or the mold, and thus an effect of economically using the present invention in fabricating micro patterns of various shapes is provided.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. An apparatus for selective micro pattern replication using ultrasonic waves, the apparatus comprising:
a to-be-processed substrate scheduled to be replicated with a first pattern in a first area which is a part of a predetermined area;
a mold provided with a second pattern at least in an area corresponding to the predetermined area, on which the to-be-processed substrate is fixed;
a masking layer provided to be contacted with the to-be-processed substrate on a side opposite to a side facing the mold and including a masking area in an area corresponding to the first area; and
a tool horn for transferring ultrasonic vibration to the masking layer, wherein
if the tool horn transfers the ultrasonic vibration to the masking layer, the to-be-processed substrate is pressed to the mold.

2. The apparatus according to claim 1, wherein the masking layer is made of a thermoplastic resin having a glass transition temperature higher than a glass transition temperature of the to-be-processed substrate.

3. An apparatus for selective micro pattern replication using ultrasonic waves, the apparatus comprising:
a to-be-processed substrate scheduled to be replicated with a first pattern in a first area which is a part of a predetermined area;
a mold on which the to-be-processed substrate is fixed;
a masking layer provided between the to-be-processed substrate and the mold and including a masking area in an area corresponding to the first area; and
a tool horn for transferring ultrasonic vibration to the to-be-processed substrate and being provided with a second pattern in an area corresponding to at least the predetermined area, wherein
if the tool horn transfers the ultrasonic vibration to the to-be-processed substrate, the to-be-processed substrate is pressed to the masking layer.

4. The apparatus according to claim 3, wherein the masking layer is made of a thermoplastic resin having a glass transition temperature higher than a glass transition temperature of the to-be-processed substrate.

5. A method of selective micro pattern replication using ultrasonic waves, the method comprising:
a step of providing a to-be-processed substrate scheduled to be replicated with a first pattern in a first area which is a part of a predetermined area;
a step of fixing the to-be-processed substrate to a mold provided with a second pattern at least in an area corresponding to the predetermined area;
a step of providing a masking layer including a masking area in an area corresponding to the first area so as to contact with the to-be-processed substrate on a side opposite to a side facing the mold; and
a step of transferring ultrasonic vibration to the masking layer and pressing the to-be-processed substrate to the mold.

6. A method of selective micro pattern replication using ultrasonic waves, the method comprising:
a step of providing a to-be-processed substrate scheduled to be replicated with a first pattern in a first area which is a part of a predetermined area;
a step of fixing the to-be-processed substrate to a mold;
a step of providing a masking layer including a masking area in an area corresponding to the first area, between the to-be-processed substrate and the mold; and
a step of transferring ultrasonic vibration to the to-be-processed substrate through a tool horn provided with the second pattern at least in an area corresponding to the predetermined area and pressing the to-be-processed substrate to the masking layer.
